(19) United States
(12) Patent Application Publication
(10) Pub. No.: US 2009/0302233 A1
(43) Pub. Date: Dec. 10, 2009

(54) CHARGED PARTICLE BEAM APPARATUS

(76) Inventor: Takashi Ogawa, Chiba (JP)

Correspondence Address: Bruce L Adams;Adams & Wilks, 17 Battery Place, Suite 1231, New York, NY, 10004, US

(21) Appl. No.: 12/310,148

(22) PCT Filed: Aug. 3, 2007
(86) PCT No.: PCT/JP2007/065236

§ 371 Date: Apr. 23, 2009

(51) Int. Cl. H01J 3/14

(52) U.S. Cl. 250/396 R

(57) ABSTRACT

A charged particle beam apparatus is provided which can apply a charged particle beam onto a sample with aberration reduced and can apply a charged particle beam with no likelihood of occurrence of discharge even the case of introducing a gas into the sample surface.

A charged particle beam apparatus 1 has: a charged particle source 9 that emits a charged particle beam I; a charged particle beam optical system 11 having: a correcting and deflecting unit 19 that corrects and deflects the charged particle beam I, and an objective lens 16 that focuses and applies the charged particle beam I onto a sample M, wherein two outer electrodes 16a and 16b and at least one intermediate electrode 16c sandwiched between the outer electrodes 16a and 16b are arranged in an application direction for application, and an objective lens control power supply 36 that can switch and apply a voltage the intermediate electrode 16c of the objective lens 16 in the charged particle beam optical system 11 so as to generate a potential difference having any one of positive and negative polarities with respect to the outer electrodes 16a and 16b.

### TECHNICAL FIELD

The present invention relates to a charged particle beam apparatus that applies a charged particle beam onto a sample to process and observe the sample.

### BACKGROUND OF THE INVENTION

Heretofore, a charged particle beam apparatus that applies a charged particle beam such as an ion beam and an electron beam onto a predetermined position for processing and observation is used in various fields. For the charged particle beam apparatus, for example, such a focused ion beam apparatus is proposed which is provided with a liquid metal ion source and an ion beam optical system that focuses the ion beam emitted from the liquid metal ion source (for instance, see Patent Reference 1). In such a focused ion beam apparatus, a focused ion beam is applied onto a predetermined position on a sample to etch the sample, or secondary electrons, for example, which are generated from the sample with application, are detected to observe the sample surface as well. In addition, a gas introduction mechanism is provided; a focused ion beam is applied as well as a predetermined gas is issued to the sample surface to facilitate etching, or to deposit a film formed of gas components.

In addition, in the charged particle beam apparatus described above, for an objective lens to focus and apply a charged particle beam onto a sample, for example, an einzel lens is used (for instance, see Non-patent Reference 1). The einzel lens is configured of three electrodes, in which two outer electrodes are grounded and a positive or negative voltage is applied to an intermediate electrode sandwiched between the outer electrodes to form an electric field, whereby a passing charged particle beam can be focused by this electric field. When the voltage having the polarity different from the polarity of the accelerating voltage of the charged particle beam is applied, the einzel lens functions as an accelerating lens that accelerates the charged particle beam with the intermediate electrode. In addition, when the voltage having the same polarity as the polarity of the accelerating voltage of the charged particle beam is applied, the einzel lens functions as a deceleration lens that decelerates the charged particle beam with the intermediate electrode. For the polarity of the voltage to be applied to the intermediate electrode, the charged particle beam can be focused even though either of a positive or negative polarity is selected. However, when the accelerating lens is adopted which applies the voltage having the polarity different from that of the charged particle beam, chromatic aberration can be made smaller, and the accelerating lens is adopted in many cases as further precision is demanded in recent years.
Patent Reference 1: JP-A-2002-251976
Non-Patent Reference 1: “Electron Ion Beam Handbook”, p. 68, Nikkan Kogyo Shimbun, Ltd., Sep. 25, 1986

### DISCLOSURE OF THE INVENTION

### Problems that the Invention is to Solve

However, in the charged particle beam apparatus described in Patent Reference 1, when the einzel lens is adopted as the objective lens and used for the accelerating lens, the absolute value of the voltage to be applied rises very high as compared with the case of using the einzel lens as the deceleration lens. On this account, as described above, when a gas is introduced into the sample surface together with application of the charged particle beam, discharge might occur because of the gas. Particularly, as further precision is demanded in recent years, because the absolute value of the voltage to be applied to the objective lens is set higher and the distance between the sample and the objective lens is set shorter, a problem arises that the likelihood of occurrence of discharge becomes greater in the case of introducing a gas.

The invention has been made in the light of circumstances described above. The invention is to provide a charged particle beam apparatus that can apply a charged particle beam onto a sample with aberration reduced, and can apply a charged particle beam with no likelihood of occurrence of discharge even the case of introducing a gas into the sample surface.

### Means for Solving the Problems

In order to solve the problems, the invention proposes the following schemes.

A charged particle beam apparatus according to the invention is characterized by including: a charged particle source operable to emit a charged particle beam; a charged particle beam optical system having a correcting and deflecting unit operable to correct and deflect the charged particle beam as necessary, and an objective lens operable to focus and apply the charged particle beam onto a sample, wherein two outer electrodes and at least one intermediate electrode sandwiched between the outer electrodes are arranged in an application direction of the charged particle beam; and an objective lens control power supply operable to switch and apply a voltage to the intermediate electrode of the objective lens in the charged particle beam optical system so as to generate a potential difference having any one of positive and negative polarities with respect to the outer electrodes.

In accordance with the charged particle beam apparatus according to the invention, when there is no likelihood of occurrence of discharge as a gas is not introduced into the sample surface, for example, the objective lens control power supply applies to the intermediate electrode such a voltage having a polarity that generates a potential difference having a polarity different from the polarity of the charged particle beam with respect to the outer electrodes, and the objective lens is turned to be an accelerating lens, whereby the charged particle beam can be effectively focused with aberration reduced. On the other hand, when a gas is introduced, for example, the objective lens control power supply applies to the intermediate electrode such a voltage having a polarity that generates a potential difference having the same polarity as the polarity of the charged particle beam with respect to the outer electrodes, and the objective lens is turned to be a deceleration lens, whereby the charged particle beam can be focused with no likelihood of occurrence of discharge.

In addition, in the charged particle beam apparatus described above, preferably, the objective lens control power supply has: a first power supply operable to apply a negative voltage so as to generate a negative potential difference with respect to the outer electrodes; a second power supply operable to apply a positive voltage so as to generate a positive potential difference with respect to the outer electrodes; and a switching unit operable to switch between the first power supply and the second power supply so as to connect any one of these power supplies to the intermediate electrode of the objective lens.

In accordance with the charged particle beam apparatus according to the invention, the objective lens control power supply has the, first power supply, the second power supply, and the switching unit, whereby either a positive or negative voltage is switched and applied to the intermediate electrode of the objective lens. Thus, when there is no likelihood of occurrence of discharge as a gas is not introduced into the sample surface, for example, the objective lens can be used as an accelerating lens, whereas when a gas is introduced, for example, the objective lens can be used as a deceleration lens.

In addition, in the charged particle beam apparatus described above, the objective lens control power supply may be a bipolar high voltage power supply operable to switch and apply a negative voltage and a positive voltage so as to generate a potential difference having any one of positive and negative polarities with respect to the outer electrodes.

In accordance with the charged particle beam apparatus according to the invention, because the objective lens control power supply is a bipolar high voltage power supply, either a positive or negative voltage can be switched and applied to the intermediate electrode of the objective lens. Thus, when there is no likelihood of occurrence of discharge as a gas is not introduced into the sample surface, for example, the objective lens can be used as an accelerating lens, whereas when a gas is introduced, for example, the objective lens can be used as a deceleration lens.

In addition, in the charged particle beam apparatus described above, the intermediate electrode of the objective lens may have a first electrode and a second electrode arranged on the sample side more than the first electrode is located, and the objective lens control power supply may have a first power supply connected to the first electrode and operable to apply a voltage having a polarity different from a polarity of the charged particle beam so as to generate a potential difference having a polarity different from the polarity of the charged particle beam with respect to the outer electrodes, and a second power supply connected to the second electrode and operable to apply a voltage having the same polarity as a polarity of the charged particle beam so as to generate a potential difference having the same polarity as the polarity of the charged particle beam with respect to the outer electrodes.

In accordance with the charged particle beam apparatus according to the invention, the objective lens control power supply has the first power supply and the second power supply, whereby the positive and negative voltages different from each other can be applied to the first electrode and the second electrode of the intermediate electrode of the objective lens. Thus, when there is no likelihood of occurrence of discharge as a gas is not introduced into the sample surface, for example, a voltage having a polarity different from the polarity of the charged particle beam is applied to the first electrode so as to generate a potential difference having a polarity different from the polarity of the charged particle beam with respect to the outer electrodes, and the objective lens can be used as an accelerating lens to focus the charged particle beam. In addition, when a gas is introduced, for example, a voltage having the same polarity as the polarity of the charged particle beam is applied to the second electrode so as to generate a potential difference having the same polarity as the polarity of the charged particle beam with respect to the outer electrodes, and the objective lens can be used as a deceleration lens to focus the charged particle beam. In addition, although the absolute value of the voltage to be applied to the first electrode as the accelerating lens becomes higher than the absolute value of the voltage to be applied to the second electrode as the deceleration lens, the second electrode is arranged on the sample side, and the first electrode is arranged at the position apart from the sample. Thus, the likelihood of occurrence of discharge when the objective lens is used as the accelerating lens can be reduced as well. In addition, the first power supply and the second power supply having different polarities of the voltage to be applied are connected to the electrodes different from each other. Accordingly, there is no need to provide a complicated insulating structure to safely switch the high polarity of the voltage with no short circuit, which can intend the simplification of the apparatus and cost reductions.

In addition, in the charged particle beam apparatus described above, as the objective lens, the charged particle beam optical system may have two of the objective lenses including a first objective lens, and a second objective lens arranged on the sample side more than the first objective lens is located, and the objective lens control power supply may have: a first power supply connected to the intermediate electrode of the first objective lens and operable to apply a voltage having a polarity different from a polarity of the charged particle beam so as to generate a potential difference having a polarity different from the polarity of the charged particle beam with respect to the outer electrodes of the first objective lens, and a second power supply connected to the intermediate electrode of the second objective lens and operable to apply a voltage having the same polarity as a polarity of the charged particle beam so as to generate a potential difference having the same polarity as the polarity of the charged particle beam with respect to the outer electrodes of the second objective lens.

In accordance with the charged particle beam apparatus according to the invention, the objective lens control power supply has the first power supply and the second power supply, whereby positive and negative voltages different from each other can be applied to the intermediate electrode of the first objective lens and the intermediate electrode of the second objective lens. Thus, when there is no likelihood of occurrence of discharge as a gas is not introduced into the sample surface, for example, a voltage having a polarity different from the polarity of the charged particle beam is applied to the intermediate electrode so as to generate a potential difference having a polarity different from the polarity of the charged particle beam with respect to the outer electrodes in the first objective lens, and the objective lens can be used as an accelerating lens to focus the charged particle beam. In addition, when a gas is introduced, for example, a voltage having the same polarity as the polarity of the charged particle beam is applied to the intermediate electrode so as to generate a potential difference having the same polarity as the polarity of the charged particle beam with respect to the outer electrodes in the second objective lens, and the objective lens can be used as a deceleration lens to focus the charged particle beam. In addition, although the absolute value of the voltage to be applied to the intermediate electrode of the first objective lens as the accelerating lens becomes higher than the absolute value of the voltage to be applied to the intermediate electrode of the second objective lens as the deceleration lens, the second objective lens is arranged on the sample side, and the first objective lens is arranged at the position apart from the sample. Thus, the likelihood of occurrence of discharge when the objective lens is used as the accelerating lens can be reduced as well. In addition, because the first power supply and the second power supply having different polarities of the voltage to be applied are connected to different objective lenses. Accordingly, there is no need to provide a complicated insulating structure to safely switch the high polarity of the voltage with no short circuit, which can intend the simplification of the apparatus and cost reductions.

In addition, in the charged particle beam apparatus described above, preferably, the charged particle beam apparatus includes: a control power supply unit operable to drive the correcting and deflecting unit in the charged particle beam optical system; and a control unit having a preset adjustment value of the correcting and deflecting unit in the charged particle beam optical system for applying the charged particle beam onto the sample at an optimum condition when a voltage is applied to the intermediate electrode of the objective lens by the objective lens control power supply to generate a potential difference having any one of positive and negative polarities between the intermediate electrode and the outer electrodes, wherein the control unit selects the adjustment value depending on whether a potential difference generated between the intermediate electrode and the outer electrodes by the objective lens control power supply is either a positive or negative polarity, and drives the correcting and deflecting unit in the charged particle beam optical system by the control power supply unit.

In accordance with the charged particle beam apparatus according to the invention, when a potential difference having either a positive or negative polarity is generated between the intermediate electrode and the outer electrodes, in each case of generating positive and negative polarities, the control unit drives the correcting and deflecting unit by the control power supply to automatically adjust the charged particle beam based on the adjustment values set in advance. Accordingly, even though the voltage to be applied to the intermediate electrode is changed, the charged particle beam can be applied at the optimum conditions all the time.

In addition, in the charged particle beam apparatus described above, preferably, the charged particle beam apparatus includes: a gas introduction mechanism operable to introduce a gas into an application position at which the charged particle beam is applied onto the sample, and a control unit operable to switch a polarity of a voltage to be applied to the intermediate electrode of the objective lens by the objective lens control power supply depending on whether the gas introduction mechanism is driven or not.

In accordance with the charged particle beam apparatus according to the invention, when the gas introduction mechanism is not driven, a voltage having a polarity different from the polarity of the charged particle beam is applied to the intermediate electrode of the objective lens to use the objective lens as an accelerating lens, whereas when the gas introduction mechanism is driven, the control unit automatically switches the voltage to be applied to the intermediate electrode of the objective lens to use the objective lens as a deceleration lens, whereby the charged particle beam can be applied with no likelihood of occurrence of discharge.

### Advantage of the Invention

In accordance with the charged particle beam apparatus according to the invention, the objective lens control power supply is provided, whereby the charged particle beam can be applied onto the sample with aberration reduced, as well as the charged particle beam can be applied with no likelihood of occurrence of discharge even the case of introducing a gas into the sample surface.

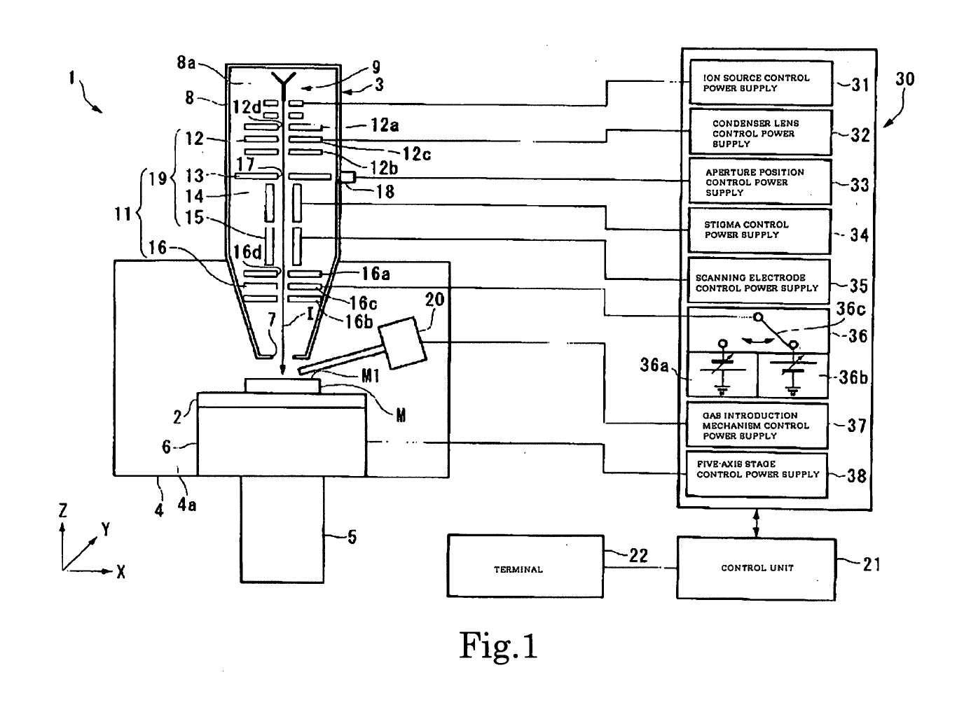

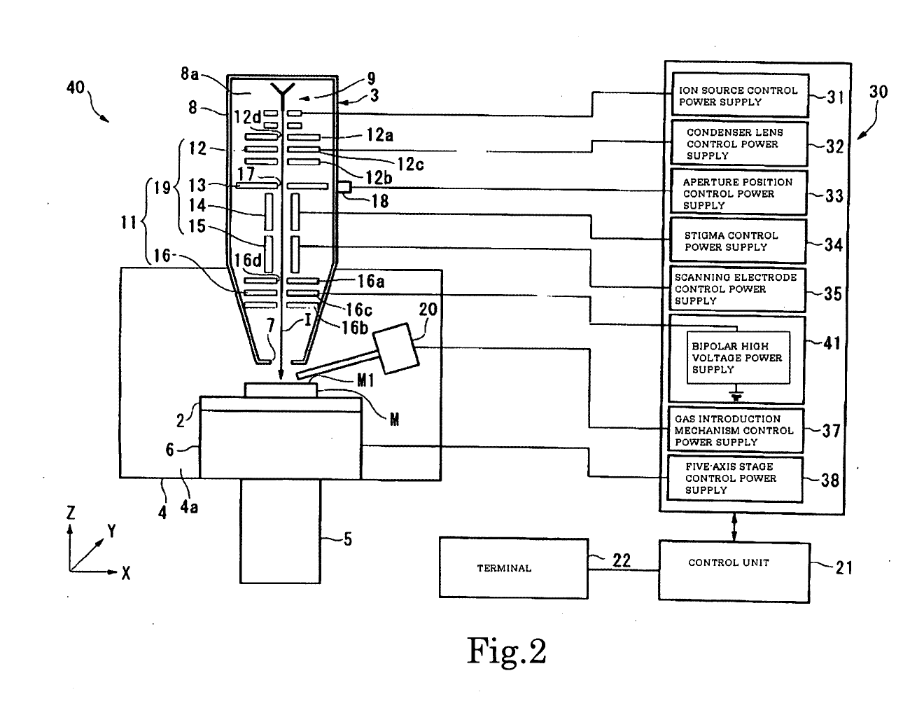

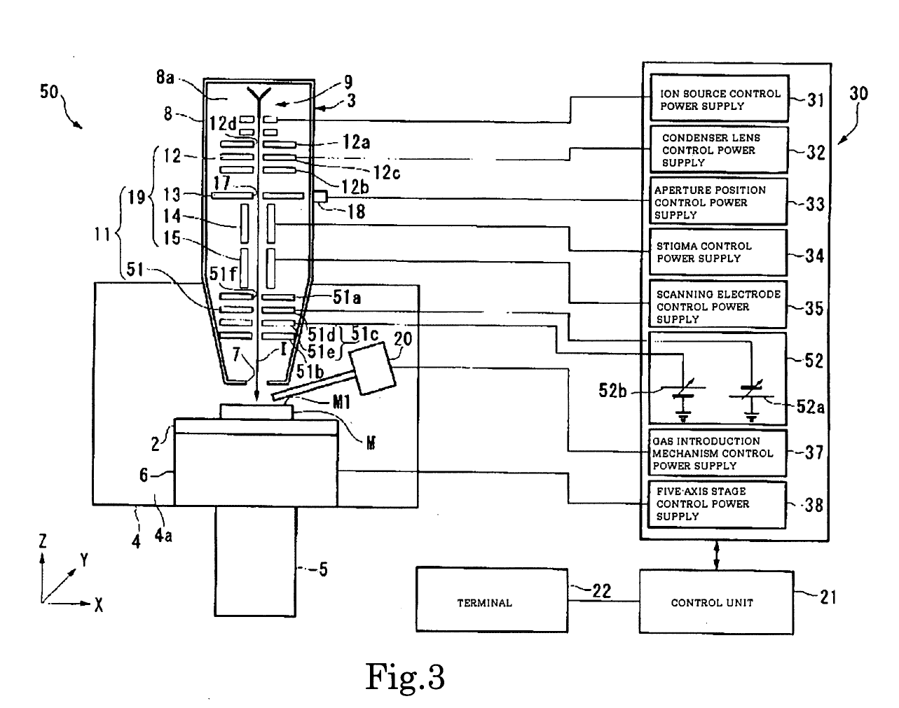

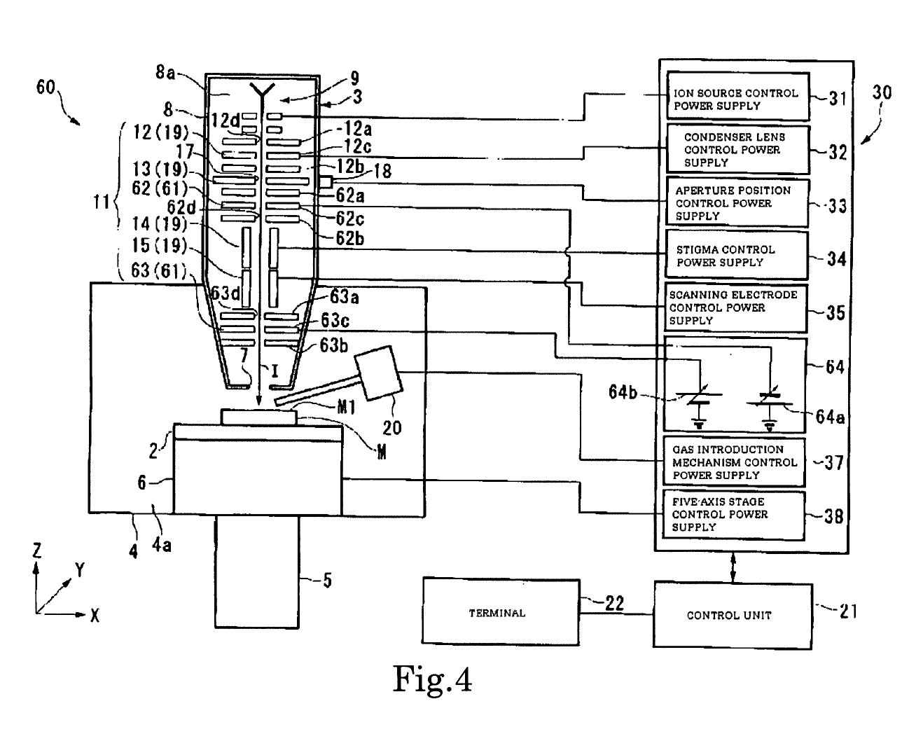

### BRIEF DESCRIPTION OF THE DRAWINGS

[FIG. 1] It is a block diagram depicting a charged particle beam apparatus according to a first embodiment of the invention;

[FIG. 2] It is a block diagram depicting a charged particle beam apparatus according to a modification of the first embodiment of the invention;

[FIG. 3] It is a block diagram depicting a charged particle beam apparatus according to a second embodiment of the invention; and

[FIG. 4] It is a block diagram depicting a charged particle beam apparatus according to a third embodiment of the invention.

### DESCRIPTION OF REFERENCE NUMERALS AND SIGNS

1, 40, 50, 60 focused ion beam apparatus (charged particle beam apparatus)
9 ion source (charged particle source)
11 ion beam optical system (charged particle beam optical system)
16, 51, 61 objective lens
16a, 16b, 51a, 51b outer electrode
16c, 51c intermediate electrode
19 correcting and deflecting unit
20 gas introduction mechanism
21 control unit
30 control power supply unit
36, 52, 64 objective lens control power supply
36a, 52a, 64a first power supply
36b, 52b, 64b second power supply
36c switching unit
41 bipolar high voltage power supply (objective lens control power supply)
51d first electrode
51e second electrode
62 first objective lens
62a, 62b outer electrode
62c intermediate electrode
63 second objective lens
63a, 63b outer electrode
63c intermediate electrode
M sample
I ion beam (charged particle beam)

### BEST MODE FOR CARRYING OUT THE INVENTION

### First Embodiment

FIG. 1 shows a first embodiment of the invention. As shown in FIG. 1, a focused ion beam apparatus (FIB) 1, which is a charged particle beam apparatus, applies an ion beam I that is a charged particle beam onto a sample M, whereby the surface of the sample M is processed. For example, the focused ion beam apparatus can be used as follows: a wafer is arranged as the sample M and a sample can be prepared for use in TEM (transmission electron microscope) observation, or a photomask in photolithographic techniques is used as the sample M and the photomask can be corrected. Hereinafter, the detail of the focused ion beam apparatus 1 in the embodiment will be described.

As shown in FIG. 1, the focused ion beam apparatus 1 has a sample stage 2 on which the sample M can be placed, and an ion beam lens barrel 3 that can apply the ion beam I onto the sample M placed on the sample stage 2. The sample stage 2 is arranged in an interior 4a of the vacuum chamber 4. In the vacuum chamber 4, a vacuum pump 5 is provided, which can evacuate the interior 4a to a high vacuum atmosphere. In addition, the sample stage 2 is provided with a five-axis stage 6. The five-axis stage 6 is connected to a five-axis stage control power supply 38, which is driven by the five-axis stage control power supply 38 and can move the sample M in the Z-direction that is the application direction of the ion beam I and in the X-direction and the Y-direction that are two axes nearly orthogonal to the Z-direction by a predetermined amount. In addition, the five-axis stage 6 can rotate the sample in the XY-plane, not shown, and tilt the sample about the X-axis.

The ion beam lens barrel 3 has a barrel body 8 having an application port 7 that is formed at the tip end thereof and communicates with the vacuum chamber 4, and an ion source 9 that is a charged particle source accommodated in an interior 8a of the barrel body 8 on the base end side thereof. For example, the ion configuring the ion source 9 is gallium ions (Ga⁺). The ion source 9 is connected to an ion source control power supply 31. Then, the ion source control power supply 31 applies the accelerating voltage and the extraction voltage to accelerate ions extracted from the ion source 9 for emitting the ions as the ion beam I.

In addition, in the interior 8a of the barrel body 8, at the tip end side more than the ion source 9 is located, an ion beam optical system 11 is provided, which is a charged particle beam optical system that corrects, deflects and focuses the ion beam I emitted from the ion source 9 as necessary. As the ion beam optical system 11, in order from the base end side, the ion beam optical system 11 has a condenser lens 12, a movable diaphragm 13, a stigma 14, a scanning electrode 15, and an objective lens 16.

The condenser lens 12 is a lens configured of three electrodes, outer electrodes 12a and 12b and an intermediate electrode 12c sandwiched between the outer electrodes 12a and 12b, each having a through hole 12d, in which the intermediate electrode 12c is connected to a condenser lens control power supply 32. Then, the outer electrode 12b is grounded and a voltage is applied to the intermediate electrode 12c by the condenser lens control power supply 32, whereby an electric field is formed to focus the ion beam I passing through the through holes 12d in the state in which the ion beam I is emitted from the ion source 9 and diffused.

In addition, the movable diaphragm 13 has an aperture 17 that is a through hole having a predetermined diameter, and an aperture driving unit 18 that moves the aperture 17 in the X-direction and the Y-direction. The aperture 17 focuses the ion beam I applied from the condenser lens 12 depending on the diameter thereof. The aperture driving unit 18 is connected to an aperture position control power supply 33, which can adjust the position of the aperture 17 by electric power fed from the aperture position control power supply 33. In addition, the aperture 17 has different diameters, not shown, and a plurality of apertures is provided. Thus, the aperture driving unit 18 selects the aperture 17 with the optimum diameter, and adjusts the aperture 17 in such a way that the axis of the aperture 17 is nearly matched with the axis of the ion beam I, whereby the ion beam I can be focused to a predetermined beam diameter with coma aberration suppressed.

The stigma 14 is electrodes that conduct astigmatism correction of the ion beam I passing therethrough, and astigmatism correction is conducted by applying voltage by a stigma control power supply 34. In addition, the scanning electrode 15 forms a parallel electric field by applying voltage by a scanning electrode control power supply 35, and can deflect the ion beam I passing therethrough in the X-direction and the Y-direction by a predetermined amount. Then, the ion beam I can thus be scanned on the sample M, or the application position can be shifted so that the ion beam I can be applied onto a predetermined position. In addition, for shifting the application position, such a scheme may be possible that an electrode is separately provided.

As described above, in the embodiment, the condenser lens 12, the movable diaphragm 13, the stigma 14, and the scanning electrode 15 configure a correcting and deflecting unit 19 to correct and deflect the ion beam I emitted from the ion source 9 as necessary. In addition, for the components configuring the correcting and deflecting unit 19, the components are not limited to those described above, and all of the configurations above are not necessarily required.

In addition, the objective lens 16 is one that focuses the ion beam I corrected and deflected by the correcting and deflecting unit 19 described above to be the focus position on a surface M1 of the sample M, thereby applying the ion beam I onto a predetermined position on the sample M. More specifically, the objective lens 16 is an einzel lens, which is configured of three electrodes, outer electrodes 16a and 16b and an intermediate electrode 16c sandwiched between the outer electrodes 16a and 16b, each having a through hole 16d. Although these electrode are formed of a metal having conductivity, metals having high corrosion resistance against a corrosive gas such as xenon fluoride (xeF₂) or chlorine (Cl₂) are preferable. For example, SUS316L, hastelloy, nickel or the like is selected. In addition, the outer electrodes 16a and 16b are grounded, whereas the intermediate electrode 16c is connected to an objective lens control power supply 36. The objective lens control power supply 36 has a first power supply 36a that can apply negative voltage so as to generate a potential difference having a polarity (negative) different from the polarity (positive) of gallium ions forming the ion beam I with respect to the outer electrodes 18a and 18b, and a second power supply 36b that can apply positive voltage so as to generate a potential difference having the same polarity (positive) as the polarity (positive) of gallium ions. These components can be connected by being switched by a switching unit 36c.

In addition, the focused ion beam apparatus 1 has a gas introduction mechanism 20 that can issue a gas to the application position of the ion beam I on the surface M1 of the sample M. The gas from the gas introduction mechanism 20 allows facilitation of etching by the ion beam I or deposition of gas components depending on the type of gas. The gas introduction mechanism 20 is connected to a gas introduction mechanism control power supply 37, which is driven by the gas introduction mechanism control power supply 37 to issue a gas.

In addition, the focused ion beam apparatus 1 has a control unit 21, and the control unit 21 controls the individual outputs of a control power supply unit 30 configured of the ion source control power supply 31, the condenser lens control power supply 32, aperture control power supply 33, the stigma control power supply 34, the scanning electrode control power supply 35, the objective lens control power supply 36, the gas introduction mechanism control power supply 37, and the five-axis stage control power supply 38 described above. In other words, under control conducted by the control unit 21, the ion source control power supply 31 is driven to emit the ion beam I from the ion source 9 in a predetermined current amount at a predetermined accelerating voltage, and the condenser lens control power supply 32 is driven to focus the ion beam I by the condenser lens 12 at a predetermined reduction ratio. In addition, the aperture position control power supply 33 is driven to adjust the diameter and the position of the aperture 17, and the stigma control power supply 33 is driven to correct astigmatism of the ion beam I. In addition, the scanning electrode control power supply 34 is driven to scan the ion beam I by the scanning electrode 15. Moreover, the objective lens control power supply 36 is driven to switch between the polarities of the positive voltage and the negative voltage by the switching unit 36c, and to change the absolute value for adjusting the focus position. In addition, the gas introduction mechanism control power supply 37 is driven to introduce a gas in a predetermined amount. In addition, the five-axis stage control power supply 38 is driven to adjust the position of the sample M in the X-, Y-, and Z-axis directions individually.

Here, in order to optimally adjust the diameter beam for application at the same focus position and application position when the polarity is switched by the switching unit 36c of the objective lens control power supply 36, it is necessary to adjust the condenser lens 12, the movable diaphragm 13, the stigma 14, and the scanning electrode 15, which are the individual components of the correcting and deflecting unit 19. Then, the adjustment values of the individual components of the correcting and deflecting unit 19 are measured in advance, and set in the control unit 21. In other words, when the polarity of the voltage to be applied to the intermediate electrode 16c of the objective lens 16 is changed by the objective lens control power supply 36, the control unit 21 drives the individual power supplies of the control power supply unit 30 based on the adjustment values set in advance, and adjusts the correcting and deflecting unit 19 to apply the ion beam I at the optimum conditions. In addition, a terminal 22 is connected to the control unit 21, and an operator can variously conduct adjustment from the terminal 22.

Moreover, the control unit 21 can switch the polarity of the voltage to be applied to the intermediate electrode 16c depending on whether the gas introduction mechanism 20 is driven or not. In other words, when the ion beam I is applied in the state in which the gas introduction mechanism 20 is not driven with no introduction of gas, the control unit 21 drives the switching unit 36c to connect the first power supply 36a to the intermediate electrode 16c of the objective lens 16. Thus, under the environment with no introduction of gas and no likelihood of the occurrence of discharge, the objective lens 16 is used as the accelerating lens to reduce aberration and to effectively focus and apply the ion beam I onto the sample M.

In addition, for example, suppose that an operator makes entries from the terminal 26 to apply the ion beam I while a gas is introduced by the gas introduction mechanism 20. In this case, the control unit 21 first drives the switching unit 36c of the objective lens control power supply 36 to switch the power supply connected to the intermediate electrode 16c of the objective lens 16 from the first power supply 36a to the second power supply 36b to turn the voltage to be applied to the negative voltage, and allows the objective lens 16 to function as the deceleration lens. Moreover, in response to switching the voltage, the control unit 21 drives the individual components of the control power supply unit 30 to adjust the individual components of the correcting and deflecting unit 19 based on the individual adjustment values set in advance. In other words, the voltage to be applied from the condenser lens control power supply 32 to the condenser lens 12 is changed by a predetermined amount. In addition, electric power is fed from the aperture position control power supply 33 to the aperture driving unit 18 to move the aperture 17 by a predetermined amount. In addition, a predetermined voltage to be applied from the stigma control power supply 34 to the stigma 14 is changed to again adjust astigmatism correction. In addition, a predetermined voltage to be applied from the scanning electrode control power supply 35 to the scanning electrode 15 is changed to again adjust the application position.

Then, after all the adjustments are completed, the control unit 21 drives the gas introduction mechanism control power supply 37 to issue a gas from the gas introduction mechanism 20, and drives the ion source control power supply 31 to emit the ion beam I from the ion source 9 for applying the ion beam I onto the sample M. At this time, because the objective lens 16 functions as the deceleration lens, the absolute value of the voltage to be applied to the intermediate electrode 16c can be suppressed, whereby the occurrence of discharge caused by gas can be prevented. Thus, the ion beam I is focused and applied onto the sample M to facilitate etching, or to conduct deposition with no likelihood of occurrence of discharge caused by gas. In addition, because of no likelihood of occurrence of discharge, durability can be improved, and the lifetime of the ion beam lens barrel 3 in using gas can be prolonged. In addition, as described above, the individual components of the correcting and deflecting unit 19 are automatically adjusted to the optimum conditions based on the adjustment value, whereby aberration and the like are corrected to apply the ion beam I at the accurate position.

Then, when an instruction is inputted to stop the application of the ion beam I onto the sample M, the control unit 21 stops driving the ion source control power supply 31 and the gas introduction mechanism control power supply 37 to terminate the application of the ion beam I and the issuance of gas. Moreover, the control unit 21 evacuates gas in the interior 4a of the vacuum chamber 4 by the vacuum pump 5. Then, in the stage of completion of evacuation, the control unit 21 drives the switching unit 36c of the objective lens control power supply 36 to connect to the first power supply 36a, and again adjusts the individual components of the correcting and deflecting unit 19 based on the individual adjustment values, whereby the objective lens 16 is again used as the accelerating lens and the ion beam I can be applied at the optimum conditions in association therewith.

In addition, in the discussion above, the control unit 21 automatically conducts switching the polarity of the voltage to be applied by the objective lens control power supply 36 and adjusting the individual components of the correcting and deflecting unit 19. However, the invention is not limited thereto. Such a scheme may be possible that an operator makes entries for switching and adjustment in the terminal 22. In addition, the objective lens 16 is an einzel lens configured of the outer electrodes 16a and 16b and the intermediate electrode 16c. However, the invention is not limited thereto. For example, such a configuration may be possible that a potential difference is generated between the outer electrode 16a, one hand, and the outer electrode 16b, the other hand. Also in this case, the voltage to be applied can be switched in such a way that the potential difference having relatively different polarity is generated with respect to the outer electrodes 16a and 16b, whereby the similar advantages can be expected.

In addition, the objective lens control power supply is not limited to the configuration described above. FIG. 2 shows a modification according to the embodiment. As shown in FIG. 2, a focused ion beam apparatus 40 according to the modification of the embodiment has a bipolar high voltage power supply 41 as an objective lens control power supply, which can switch between the negative voltage and the positive voltage for application. According to the focused ion beam apparatus 40, the similar advantages can be expected. In other words, because the bipolar high voltage power supply 41 can apply the positive and negative voltages different from each other to the intermediate electrode 16c of the objective lens 16, when there is no likelihood of occurrence of discharge as a gas is not introduced into the surface M1 of the sample M, for example, the negative voltage is applied to the intermediate electrode 16c so as to generate a potential difference having the polarity (negative) different from the polarity (positive) of the ion beam I with respect to the outer electrodes 16a and 16b, whereby the objective lens 16 is used as the accelerating lens to effectively focus the ion beam I with aberration reduced. In addition, when a gas is introduced by the gas introduction mechanism 20, for example, the polarity is switched to apply the positive voltage to the intermediate electrode 16c as the objective lens 16 is used as the deceleration lens, and the ion beam I can be focused with no likelihood of occurrence of discharge caused by gas.

### Second Embodiment

FIG. 3 shows a second embodiment of the invention. In this embodiment, the members common in the members used in the embodiment described above are designated the same numerals and signs for omitting the descriptions.

As shown in FIG. 3, in a focused ion beam apparatus 50 according to the embodiment, an objective lens 51 has two outer electrodes 51a and 51b, and an intermediate electrode 51c sandwiched between the outer electrodes 51a and 51b. For the intermediate electrode 51c, two electrodes are included: a first electrode 51d, and a second electrode 51e arranged on the sample M side more than the first electrode 51d is located. In these outer electrodes 51a and 51b and the intermediate electrode 51c, a through hole 51f is formed, and the ion beam I passing therethrough can be focused. In addition, to the intermediate electrode 51c, an objective lens control power supply 52 of a control power supply unit 30 is connected. More specifically, the objective lens control power supply 52 has a first power supply 52a that can apply the negative voltage different from the polarity (positive) of the ion beam I, and a second power supply 52b that can apply the same positive voltage as the polarity (positive) of the ion beam I. The first power supply 52a is connected to the first electrode 51d of the intermediate electrode 51c. In addition, the second power supply 52b is connected to the second electrode 51e of the intermediate electrode 51c.

In the focused ion beam apparatus 50 according to the embodiment, when the ion beam I is applied in the case in which the gas introduction mechanism 20 is not driven, a control unit 21 applies the negative voltage to the first electrode 51d of the objective lens 51 by the first power supply 52a, whereas the control unit 21 stops driving the second power supply 52b in the objective lens control power supply 52. On this account, in the objective lens 51, the negative potential difference different from the polarity (positive) of the ion beam I is generated between the first electrode 51d of the intermediate electrode 51c and the outer electrodes 51a and 51b. In other words, the objective lens 51 functions as the accelerating lens to effectively focus the ion beam I with aberration reduced. In addition, when the ion beam I is applied in the state in which the gas introduction mechanism 20 is driven, the control unit 21 applies the positive voltage to the second electrode 51e of the objective lens 51 by the second power supply 52b, whereas the control unit 21 stops driving the first power supply 52a in the objective lens control power supply 52. On this account, in the objective lens 51, the same positive potential difference as the polarity (positive) of the ion beam I is generated between the second electrode 51e of the intermediate electrode 51c and the outer electrodes 51a and 51b. In other words, the objective lens 51 functions as the deceleration lens to focus the ion beam I with no likelihood of occurrence of discharge caused by gas introduced by the gas introduction mechanism 20. In addition, although the absolute value of the voltage to be applied to the first electrode 51d as the accelerating lens becomes higher than the absolute value of the voltage to be applied to the second electrode 51e as the deceleration lens, the likelihood of occurrence of discharge when the objective lens 51 is used as the accelerating lens can be reduced as well because the second electrode is arranged on the sample M side and the first electrode 51d is arranged at the position apart from the sample M.

In addition, as described above, in switching the polarity of the voltage to be applied by the objective lens control power supply 52, because the first power supply 52a and the second power supply 52b are connected to the electrodes different from each other, whereby only thing to do is simply switching these power supplies to be driven and not to be driven. Accordingly, to the objective lens control power supply 52, there is no need to provide a complicated insulating structure to safely switch the high polarity of the voltage with no short circuit, which can intend the simplification of the apparatus and cost reductions.

### Third Embodiment

FIG. 4 shows a third embodiment of the invention. In this embodiment, the members common in the members used in the embodiment described above are designated the same numerals and signs for omitting the descriptions.

As shown in FIG. 4, a focused ion beam apparatus 60 according to the embodiment has two objective lenses as an objective lens 61, a first objective lens 62 and a second objective lens 63. The first objective lens 62 is an einzel lens configured of three electrodes including two outer electrodes 62a and 62b and an intermediate electrode 62c, each having a through hole 62d. Similarly, the second objective lens 63 is an einzel lens configured of three electrodes including outer electrodes 63a and 63b and an intermediate electrode 63c, each having a through hole 63d. In addition, the second objective lens 63 is arranged on the sample M side more than the first objective lens 62 is located.

In addition, to the intermediate electrodes 62c and 63c of the first objective lens 62 and the second objective lens 63, an objective lens control power supply 64 of a control power supply unit 30 is connected. More specifically, the objective lens control power supply 64 has a first power supply 64a that can apply the negative voltage different from the polarity (positive) of the ion beam I, and a second power supply 64b that can apply the same positive voltage as the polarity (positive) of the ion beam I. The first power supply 64a is connected to the intermediate electrode 62c of the first objective lens 62. In addition, the second power supply 64b is connected to the intermediate electrode 63c of the second objective lens 63.

Also in the focused ion beam apparatus 60 according to the embodiment, as similar to the second embodiment, when the ion beam I is applied in the state in which the gas introduction mechanism 20 is not driven, the control unit 21 applies the negative voltage to the intermediate electrode 62c of the first objective lens 62 by the first power supply 64a, whereas the control unit 21 stops driving the second power supply 64b in the objective lens control power supply 64. On this account, in the first objective lens 62, the negative potential difference different from the polarity (positive) of the ion beam I is generated between the intermediate electrode 62c and the outer electrodes 62a and 62b. In other words, the first objective lens 62 functions as the accelerating lens to effectively focus the ion beam I with aberration reduced.

In addition, when the ion beam I is applied in the state in which the gas introduction mechanism 20 is driven, the control unit 21 applies the positive voltage to the intermediate electrode 63c of the second objective lens 63 by the second power supply 64b, whereas the control unit 21 stops driving the first power supply 64a in the objective lens control power supply 64. On this account, in the second objective lens 63, the same positive potential difference as the polarity (positive) of the ion beam I is generated between the intermediate electrode 63c and the outer electrodes 63a and 63b. In other words, the second objective lens 63 functions as the deceleration lens to focus the ion beam I with no likelihood of occurrence of discharge caused by gas introduced by the gas introduction mechanism 20.

In addition, although the absolute value of the voltage to be applied to the intermediate electrode 62c of the first objective lens 62 as the accelerating lens becomes higher than the absolute value of the voltage to be applied to the intermediate electrode 63c of the second objective lens 63 as the deceleration lens, the likelihood of occurrence of discharge when the first objective lens 62 is used can be reduced as well because the second objective lens 63 is arranged on the sample side, and the first objective lens 62 is arranged at the position apart from the sample. M. In addition, as similar to the second embodiment, to the objective lens control power supply 64, there is no need to provide a complicated insulating structure to safely switch the high polarity of the voltage with no short circuit, which can intend the simplification of the apparatus and cost reductions.

As discussed above, the embodiments of the invention are described in detail with reference to the drawings. Specific configurations are not limited to these embodiments. Design modifications and the like are included within the scope of the teachings of the invention.

In addition, in the focused ion beam apparatus according to each of the embodiments, for the ion source 9, gallium ions are taken as an example. However, the invention is not limited thereto. For example, for example, anions such as a noble gas (Ar) or an alkaline metal (Cs) may be used. In addition, in the charged particle beam apparatus according to each of the embodiments, the focused ion beam apparatus is taken as an example. However, the invention is not limited thereto. For example, the similar advantages can be expected in a scanning electron microscope (SEM) and the like, which can apply an electron beam as the charged particle beam. In addition, as described above, when an anion is selected as the ion source of the focused ion beam apparatus, or when a charged particle beam having a negative polarity is applied such as an electron beam applied in the scanning electron microscope, the polarity of the voltage to be applied to the intermediate electrode of the objective lens is inverted, whereby the similar advantages can be expected.

### INDUSTRIAL APPLICABILITY

In accordance with the charged particle beam apparatus according to the invention, because the objective lens control power supply is provided to apply the charged particle beam onto the sample with aberration reduced, high resolution observation can be conducted, as well as the charged particle beam can be applied with no likelihood of occurrence of discharge even the case of introducing a gas into the sample surface.

1. A charged particle beam apparatus characterized by comprising:
a charged particle source operable to emit a charged particle beam;
a charged particle beam optical system having a correcting and deflecting unit operable to correct and deflect the charged particle beam as necessary, and an objective lens operable to focus and apply the charged particle beam onto a sample, wherein two outer electrodes and at least one intermediate electrode sandwiched between the outer electrodes are arranged in an application direction of the charged particle beam; and
an objective lens control power supply operable to switch and apply a voltage to the intermediate electrode of the objective lens in the charged particle beam optical system so as to generate a potential difference having any one of positive and negative polarities with respect to the outer electrodes.

2. The charged particle beam apparatus according to claim 1, characterized in that the objective lens control power supply has:
a first power supply operable to apply a negative voltage so as to generate a negative potential difference with respect to the outer electrodes;
a second power supply operable to apply a positive voltage so as to generate a positive potential difference with respect to the outer electrodes; and
a switching unit operable to switch between the first power supply and the second power supply so as to connect any one of these power supplies to the intermediate electrode of the objective lens.

3. The charged particle beam apparatus according to claim 1, characterized in that the objective lens control power supply is a bipolar high voltage power supply operable to switch and apply a negative voltage and a positive voltage so as to generate a potential difference having any one of positive and negative polarities with respect to the outer electrodes.

4. The charged particle beam apparatus according to claim 1, characterized in that the intermediate electrode of the objective lens has a first electrode and a second electrode arranged on the sample side more than the first electrode is located, and
the objective lens control power supply has a first power supply connected to the first electrode and operable to apply a voltage having a polarity different from a polarity of the charged particle beam so as to generate a potential difference having a polarity different from the polarity of the charged particle beam with respect to the outer electrodes, and a second power supply connected to the second electrode and operable to apply a voltage having the same polarity as a polarity of the charged particle beam so as to generate a potential difference having the same polarity as the polarity of the charged particle beam with respect to the outer electrodes.

5. The charged particle beam apparatus according to claim 1, characterized in that as the objective lens, the charged particle beam optical system has two of the objective lenses including a first objective lens, and a second objective lens arranged on the sample side more than the first objective lens is located, and
the objective lens control power supply has:
a first power supply connected to the intermediate electrode of the first objective lens and operable to apply a voltage having a polarity different from a polarity of the charged particle beam so as to generate a potential difference having a polarity different from the polarity of the charged particle beam with respect to the outer electrodes of the first objective lens, and
a second power supply connected to the intermediate electrode of the second objective lens and operable to apply a voltage having the same polarity as a polarity of the charged particle beam so as to generate a potential difference having the same polarity as the polarity of the charged particle beam with respect to the outer electrodes of the second objective lens.

6-7. (canceled)
